(19) United States
(12) Patent Application Publication
(10) Pub. No.: US 2024/0326477 A1
(43) Pub. Date: Oct. 3, 2024

(54) TAPE END DETECTION DEVICE, TAPE PRINTING DEVICE, AND CONTROL METHOD OF TAPE END DETECTION DEVICE

(71) Applicant: SEIKO EPSON CORPORATION, Tokyo (JP)

(72) Inventors: Kenji MOTAI, Matsumoto-shi (JP); Keishin SAKAMOTO, Matsumoto-shi (JP)

(73) Assignee: SEIKO EPSON CORPORATION, Tokyo (JP)

(21) Appl. No.: 18/616,507

(22) Filed: Mar. 26, 2024

(30) Foreign Application Priority Data
Mar. 27, 2023 (JP) 2023-050166

(51) Int. Cl. B41J 11/00; B41J 2/325; B41J 3/407; B41J 11/70; B41J 15/04

(52) U.S. Cl. CPC B41J 11/0095; B41J 2/325; B41J 3/4075; B41J 11/703; B41J 15/04

(57) ABSTRACT

A tape end detection device detects, based on a detection result of a first sensor, that a specific position other than a terminal end of a tape passed through a first detection position, detects, based on a detection result of a second sensor, that the tape cut by a cutter was discharged from a tape discharge port, and detects, based on the detection results of the first sensor and the second sensor, a tape end indicating that the terminal end of the tape passed through a feed roller.

The present application is based on, and claims priority from JP Application Serial Number 2023-050166, filed Mar. 27, 2023, the disclosure of which is hereby incorporated by reference herein in its entirety.

### BACKGROUND

### 1. Technical Field

The present disclosure relates to a tape end detection device, a tape printing device, and a control method of a tape end detection device.

### 2. Related Art

As disclosed in JP-A-8-025706, there has been known a device configured to detect whether or not a terminal end of a tape is separated from a tape roll, that is, whether or not a tape end is reached. The device disclosed in JP-A-8-025706 detects the tape end when an end portion for end identification provided at the terminal end of the tape is detected by a sensor.

The device disclosed in JP-A-8-025706 needs to be equipped with a dedicated sensor for tape end detection. In addition, the dedicated sensor is used only for detecting the tape end and cannot be used for other purposes.

### SUMMARY

A tape end detection device of the present disclosure includes: a cutter that is provided further in a first direction than is a feed roller feeding a tape fed out of a tape roll in the first direction and cuts the tape in a tape width direction; a discharge roller that is provided further in the first direction than is the cutter and feeds the tape in the first direction toward a tape discharge port; a first sensor that detects presence/absence of the tape at a first detection position located between the feed roller and the cutter; a second sensor that detects presence/absence of the tape at a second detection position located between the cutter and the tape discharge port; and a control unit. The control unit detects, based on a detection result of the first sensor, that a specific position other than a terminal end of the tape has passed through the first detection position, detects, based on a detection result of the second sensor, that the tape cut by the cutter was discharged from the tape discharge port, and detects, based on the detection results of the first sensor and the second sensor, a tape end indicating that the terminal end of the tape passed through the feed roller.

A control method of a tape end detection device of the present disclosure is a control method for controlling the tape end detection device including a cutter that is provided further in a first direction than is a feed roller feeding a tape fed out of a tape roll in the first direction and cuts the tape in a tape width direction, a discharge roller that is provided further in the first direction than is the cutter and feeds the tape in the first direction toward a tape discharge port, a first sensor that detects presence/absence of the tape at a first detection position located between the feed roller and the cutter, and a second sensor that detects presence/absence of the tape at a second detection position located between the cutter and the tape discharge port. The control method of the tape end detection device includes: detecting, based on a detection result of the first sensor, that a specific position other than a terminal end of the tape passed through the first detection position, detecting, based on a detection result of the second sensor, that the tape cut by the cutter was discharged from the tape discharge port, and detecting, based on the detection results of the first sensor and the second sensor, a tape end indicating that the terminal end of the tape passed through the feed roller.

A tape printing device of the present disclosure includes the above-described tape end detection device and a print head that performs printing on the tape fed by the feed roller.

### BRIEF DESCRIPTION OF THE DRAWINGS

FIG. 1 is an external view of a tape printing device and a tape cartridge.

FIG. 2 is a plan view of a tape discharge mechanism, illustrating a state in which a tape is not pinched between a discharge driving roller and a discharge driven roller.

FIG. 3 is a plan view of the tape discharge mechanism, illustrating a state in which the tape is pinched between the discharge driving roller and the discharge driven roller.

FIG. 4 is a view illustrating an arrangement of members in an X-axis direction from a print head to a tape discharge port.

FIG. 5 is a view illustrating an example of a tape.

FIG. 6 is a block diagram illustrating a hardware configuration of the tape printing device.

FIG. 7 is a table illustrating a relationship between a detection result of a sensor, an occurrence situation, and a device state.

FIG. 8 is a flowchart illustrating print processing.

FIG. 9 is a flowchart continued from FIG. 8.

FIG. 10 is a flowchart continued from FIG. 9.

FIG. 11 is a view illustrating a state in which a leading end of the tape is located further in a +X direction than is a first detection position.

FIG. 12 is a view illustrating a state in which the leading end of the tape is located further in a −X direction than is the first detection position.

FIG. 13 is a diagram illustrating a state in which cueing of the tape is performed when a margin length is smaller than a first distance.

FIG. 14 is a view illustrating a state in which cueing of the tape is performed when the margin length is larger than the first distance.

FIG. 15 is a view illustrating a state in which the leading end of the tape is located between the first detection position and a second detection position.

FIG. 16 is a view illustrating a state in which the leading end of the tape is located further in the −X direction than is the second detection position.

FIG. 17 is a view illustrating a state in which the leading end of the tape is located further in the +X direction than is the second detection position and a terminal end of the tape is located further in the −X direction than is the first detection position.

FIG. 18 is a view illustrating a state in which the leading end of the tape is located further in the −X direction than is the second detection position and the terminal end of the tape is located further in the −X direction than is the first detection position.

FIG. 19 is a view illustrating a state in which the tape is cut.

FIG. 20 is a view illustrating a state in which a tape is cut and the cut tape is discharged.

FIG. 21 is a view illustrating an example of a label tape.

### DESCRIPTION OF EMBODIMENTS

Hereinafter, a tape end detection device, a tape printing device, and a control method of a tape end detection device will be described with reference to the accompanying drawings. In the present embodiment, a tape printing device 1 is exemplified as the tape end detection device. The tape printing device 1 performs printing on a long tape T as a print target while feeding the tape T, subsequently cuts a printed portion of the tape T, and discharges a cut tape piece to the outside of the device. In some of the drawings, description will be made using directions based on an XYZ orthogonal coordinate system, but these directions are merely for convenience of description and do not limit the following embodiments in any way.

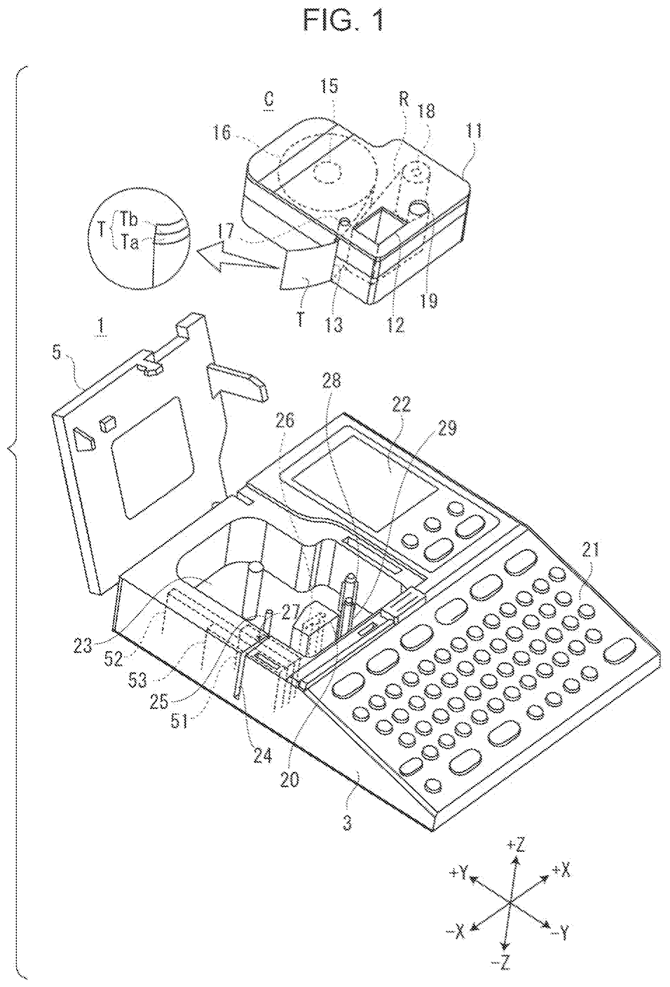

FIG. 1 is an external view of the tape printing device 1 and a tape cartridge C. The tape printing device 1 includes a device case 3 and a mounting portion cover 5. An operation key group 21, a display 22, and a cartridge mounting portion 23 are provided on a surface of the device case 3 in a +Z direction.

The operation key group 21 receives various operations of a user such as an editing operation of a print image to be printed on the tape T. The display 22 displays various kinds of information such as an edit screen of the print image. The tape printing device 1 generates print data based on the editing operation of the print image by the user, and performs print processing based on the generated print data.

The cartridge mounting portion 23 is a recessed portion that is open in the +Z direction. A tape cartridge C is detachably mounted on the cartridge mounting portion 23. The mounting portion cover 5 is rotatably attached to an end portion of the device case 3 in a +Y direction, and opens/closes the cartridge mounting portion 23.

The cartridge mounting portion 23 is provided with a print head 26 and a head cover 20. The print head 26 performs printing on the tape T. The head cover 20 partially covers the print head 26. In addition, a platen drive shaft 25, a paying-out shaft 28, and a take-up shaft 29 protrude in the +Z direction from a bottom surface of the cartridge mounting portion 23.

A tape discharge port 24 coupled to the cartridge mounting portion 23 is formed in a side portion of the device case 3 in the −X direction, and a tape discharge path 27 is formed between the cartridge mounting portion 23 and the tape discharge port 24. Inside the device case 3, an upstream sensor mechanism 51, a tape cutting mechanism 52, and a tape discharge mechanism 53 are assembled and incorporated from the +X direction so as to face the tape discharge path 27.

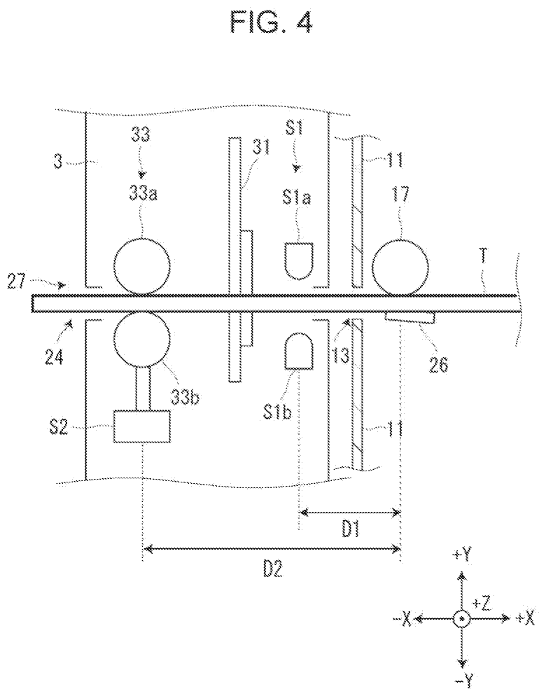

The upstream sensor mechanism 51 is a mechanism for detecting that a specific position of the tape T has passed through a detection position. The upstream sensor mechanism 51 includes an upstream sensor S1 illustrated in FIG. 4. The upstream sensor S1 is an example of a “first sensor”. The upstream sensor mechanism 51 detects a leading end and a terminal end of the tape T as the specific position of the tape T. The leading end of the tape T is an example of a “specific position other than the terminal end of the tape”.

The tape cutting mechanism 52 is a mechanism for cutting the tape T. As illustrated in FIG. 4, the tape cutting mechanism 52 includes a cutter 31 for cutting the tape T in a Z-axis direction.

The tape discharge mechanism 53 is a mechanism that discharges the tape T cut by the cutter 31 from the tape discharge port 24 and detects that the cut tape T is discharged from the tape discharge port 24. The tape discharge mechanism 53 will be described later.

The tape cartridge C includes a tape core 15, a platen roller 17, a paying-out core 18, a take-up core 19, and a cartridge case 11 that houses these components. The platen roller 17 is an example of a “feed roller”.

The tape T is wound around the tape core 15. The tape T is composed of a print tape Ta having an adhesive layer formed on the back surface thereof and a release tape Tb adhered to the print tape Ta by the adhesive layer. The tape T is housed in the cartridge case 11 as a tape roll 16 wound around the tape core 15 with the print tape Ta on the outside and the release tape Tb on the inside. An ink ribbon R is wound around the paying-out core 18. The ink ribbon R fed out from the paying-out core 18 is wound around the take-up core 19. The cartridge case 11 is provided with a head insertion hole 12 penetrating in the Z-axis direction. In addition, a tape outlet port 13 extending in the Z-axis direction is provided on a surface of the cartridge case 11 in the −X direction. The tape T fed out of the tape roll 16 is fed out from the cartridge case 11 through the tape outlet port 13.

When the tape cartridge C is mounted on the cartridge mounting portion 23, the print head 26 and the head cover 20 are inserted into the head insertion hole 12. In addition, the platen drive shaft 25, the paying-out shaft 28, and the take-up shaft 29 are engaged with the platen roller 17, the paying-out core 18, and the take-up core 19, respectively. Subsequently, when the mounting portion cover 5 is closed, the print head 26 is moved toward the platen roller 17 by a head moving mechanism (not shown). Thus, the tape T and the ink ribbon R are pinched between the print head 26 and the platen roller 17.

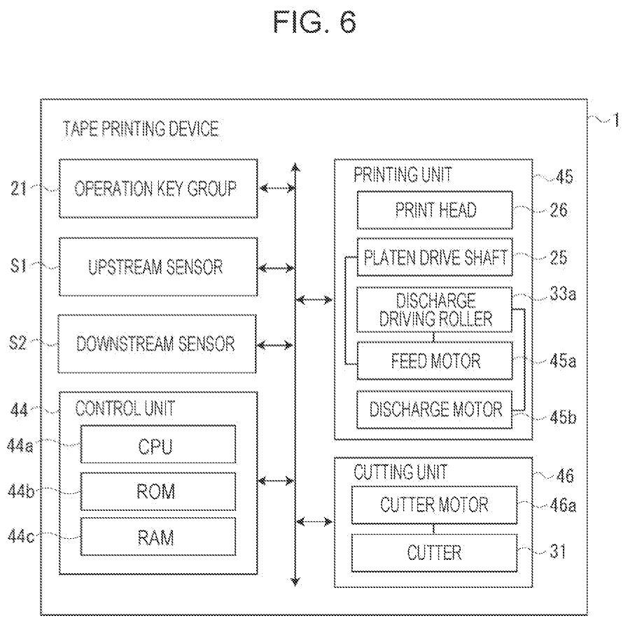

In this state, when a feed motor 45a illustrated in FIG. 6 rotates in a first rotation direction, the platen roller 17 and the take-up core 19 rotate so that the tape T is fed out from the cartridge case 11 through the tape outlet port 13 and the ink ribbon R is wound around the take-up core 19. At this time, the tape T is fed in the −X direction toward the tape discharge port 24. The −X direction is an example of a “first direction”. In addition, when the motor rotates in a second rotation direction opposite to the first rotation direction, the platen roller 17 and the paying-out core 18 rotate so that the tape T is pulled back into the cartridge case 11 and the ink ribbon R is rewound around the paying-out core 18 At this time, the tape T is fed in the +X direction. The +X direction is an example of a “second direction”.

The print head 26 generates heat according to the print data when the tape T is being fed in the −X direction. As a result, the ink of the ink ribbon R is transferred to the tape T, and a print image based on the print data is printed on the tape T.

When the printing is completed, the rear end portion of the printed portion of the tape T is fully cut by the tape cutting mechanism 52. The “fully cut” means that the entire tape T, that is, the print tape Ta and the release tape Tb are integrally cut. The cut tape piece is discharged from the tape discharge port 24 by the operation of the tape discharge mechanism 53. In this way, a tape piece on which desired characters and the like are printed is generated.

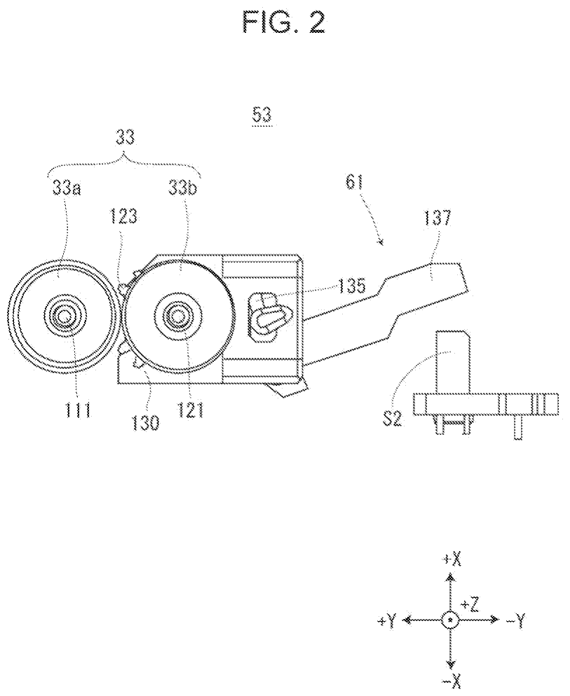

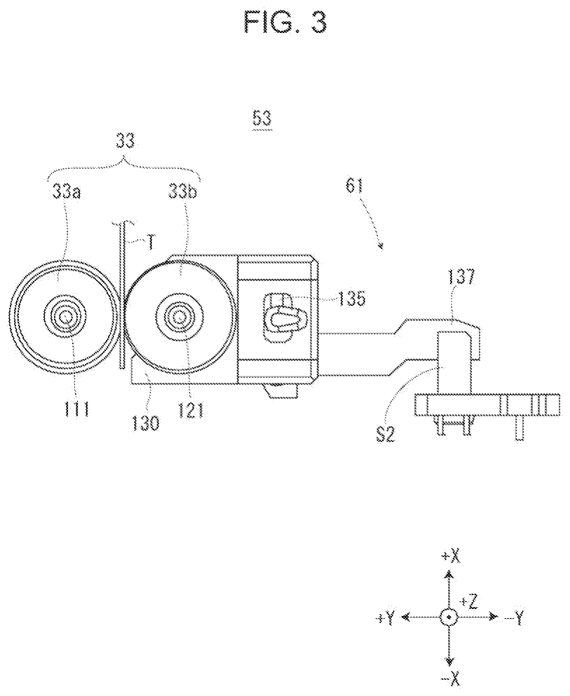

The tape discharge mechanism 53 will be described with reference to FIG. 2 and FIG. 3. The tape discharge mechanism 53 is a mechanism for discharging the cut tape T to the outside of the device and detecting that the tape T is discharged. The tape discharge mechanism 53 includes a discharge roller 33, a rotating-body slider 130, and a downstream sensor mechanism 61.

The discharge roller 33 includes a discharge driving roller 33a in rolling contact with the release tape Tb side of the tape T, and a discharge driven roller 33b in rolling contact with the print tape Ta side. The discharge driving roller 33a and the discharge driven roller 33b are examples of “a pair of rollers”.

A driving-side rotating body (not shown) is rotatably attached to a driving roller shaft 111 serving as a rotation shaft of the discharge driving roller 33a. In addition, a driven-side rotating body 123 is rotatably attached to a driven roller shaft 121 serving as a rotation shaft of the discharge driven roller 33b. The driving-side rotating body and the driven-side rotating body 123 are each formed in a gear shape, and are engaged with each other in an overlapping state. Further, the driven-side rotating body 123 is disengaged from the driving-side rotating body by the tape T pinched therebetween.

The rotating-body slider 130 rotatably supports the driven-side rotating body 123 around the driven roller shaft 121. In addition, the rotating-body slider 130 is configured to be movable in a Y-axis direction between a forward position at which the driven-side rotating body 123 engages with the driving-side rotating body and a reverse position at which the driven-side rotating body 123 disengages from the driving-side rotating body.

The downstream sensor mechanism 61 detects that the rotating-body slider 130 has slid to the reverse position. The downstream sensor mechanism 61 includes a downstream sensor S2, an engagement arm 135 which is formed in the rotating-body slider 130 and engages with an engagement hole (not shown), and a detection arm 137 which extends in a radial direction so as to be substantially orthogonal to the engagement arm 135 and of which a distal end portion faces the downstream sensor S2. The downstream sensor S2 is an example of a “second sensor”.

The engagement arm 135 and the detection arm 137 rotationally reciprocate about a shaft portion (not shown) in conjunction with the sliding of the rotating-body slider 130 between the forward position and the reverse position. The shaft portion is a mechanism that converts the rotation of the engagement arm 135 in the Y-axis direction into the rotation of the detection arm 137 in the X-axis direction. A rotation direction of the engagement arm 135 and the detection arm 137 when the rotating-body slider 130 slides from the forward position to the reverse position is referred to as a reverse rotation direction, and a rotation direction of the engagement arm 135 and the detection arm 137 when the rotating-body slider 130 slides from the reverse position to the forward position is referred to as a forward rotation direction.

The downstream sensor S2 is constituted by a transmission-type optical sensor, and is disposed so as to face the distal end portion of the detection arm 137 that is rotated to a rotation end in the reverse rotation direction. In the downstream sensor S2, the distal end portion of the detection arm 137 is inserted between a light-emitting element and a light-receiving element (both not shown) that are arranged to face each other, thereby blocking the light, and it is detected that the rotating-body slider 130 has slid to the reverse position.

As illustrated in FIG. 2, when the tape T is not pinched between the driving-side rotating body and the driven-side rotating body 123, the engagement arm 135 and the detection arm 137 rotate in the forward rotation direction. As a result, the rotating-body slider 130 moves to the forward position with respect to the discharge driving roller 33a, so that the driven-side rotating body 123 supported by the rotating-body slider 130 engages with the driving-side rotating body in an overlapping state. In this case, the downstream sensor S2 detects that the tape T is not present between the discharge driving roller 33a and the discharge driven roller 33b.

On the other hand, as illustrated in FIG. 3, when the tape T is pinched between the driving-side rotating body and the driven-side rotating body 123, the driven-side rotating body 123 is disengaged from the driving-side rotating body, and the overlapping state with the driving-side rotating body is eliminated. As a result, the rotating-body slider 130 supporting the driven-side rotating body 123 moves from the forward position to the reverse position by an amount corresponding to the elimination of the overlap state in addition to the thickness of the tape T. In conjunction with the movement of the rotating-body slider 130 to the reverse position, the engagement arm 135 and the detection arm 137 rotate in the reverse rotation direction, and the distal end portion of the detection arm 137 faces the downstream sensor S2. In this case, the downstream sensor S2 detects that the tape T is present between the discharge driving roller 33a and the discharge driven roller 33b.

An arrangement of members in the X-axis direction from the print head 26 to the tape discharge port 24 will be described with reference to FIG. 4. FIG. 4 illustrates an arrangement of each member in a state in which the tape cartridge C is mounted on the cartridge mounting portion 23. Therefore, the platen roller 17 housed in the cartridge case 11 of the tape cartridge C is disposed at a position facing the print head 26 with the tape T interposed therebetween. In addition, the tape outlet port 13 of the cartridge case 11 is located further in the −X direction than is a printing position of the print head 26.

The cutter 31 is provided further in the −X direction than is the platen roller 17. The position of the platen roller 17 in the X-axis direction corresponds to the printing position of the print head 26. In addition, the discharge roller 33 is provided further in the −X direction than is the cutter 31. Further, the tape discharge port 24 is provided further in the −X direction than is the discharge roller 33.

The upstream sensor S1 is provided between the platen roller 17 and the cutter 31. That is, the detection position of the upstream sensor S1 is located further in the −X direction than is the printing position by the print head 26, and is located further in the +X direction than is a cut position by the cutter 31. Hereinafter, the detection position of the upstream sensor S1 is referred to as a “first detection position”. The upstream sensor S1 is constituted by a transmission-type optical sensor and includes a light-emitting element Sla and a light-receiving element S1b, which are arranged to face each other with the tape T interposed therebetween.

The downstream sensor S2 is provided between the cutter 31 and the tape discharge port 24. As described above, the downstream sensor S2 detects the presence/absence of the tape T at a detection position between the discharge driving roller 33a and the discharge driven roller 33b. Hereinafter, the detection position of the downstream sensor S2 is referred to as a “second detection position”.

In the following description, a distance in the X-axis direction between the printing position of the print head 26 and the first detection position is referred to as a “first distance D1”. In the following description, a distance between the printing position of the print head 26 and the second detection position in the X-axis direction is referred to as a “second distance D2”.

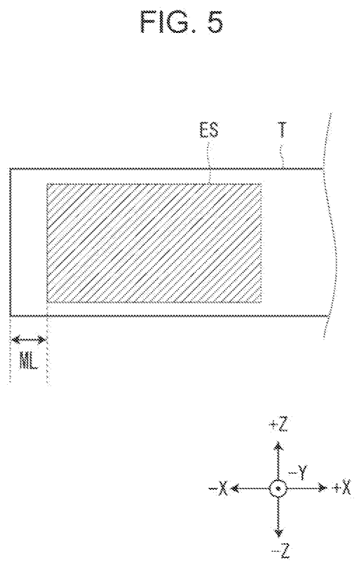

The tape T will be described with reference to FIG. 5. In FIG. 5, a hatched portion on the tape T indicates a print target area ES. The print target area ES is an area in which printing is performed by the print head 26. The print target area ES is a rectangular area including a print image to be printed on the tape T.

In the following description, a distance from the leading end of the tape T, which is an end portion of the tape T in the −X direction, to an end portion of the print target area ES in the −X direction is referred to as a “margin length ML”. The end portion of the print target area ES in the −X direction is a print start position of the tape T.

A hardware configuration of the tape printing device 1 will be described with reference to FIG. 6. The tape printing device 1 includes the operation key group 21, the upstream sensor S1, the downstream sensor S2, a control unit 44, a printing unit 45, and a cutting unit 46.

The operation key group 21 includes a print key in addition to character keys and numeric keys. The print key is a key for the user to instruct the start of printing. When the user operates the print key, the control unit 44 acquires a print start command and starts print processing.

The upstream sensor S1 detects the presence/absence of the tape T at the first detection position located between the platen roller 17 and the cutter 31. The upstream sensor S1 detects “absence of tape” in a light receiving state, and detects “presence of tape” in a light blocking state. The upstream sensor S1 is used to detect that the leading end of the tape T has passed through the first detection position and to detect a tape end. The tape end means that the terminal end of the tape T has passed through the platen roller 17.

The downstream sensor S2 detects the presence/absence of the tape T at the second detection position located between the cutter 31 and the tape discharge port 24. The downstream sensor S2 detects “absence of tape” in a light receiving state, and detects “presence of tape” in a light blocking state. The downstream sensor S2 is used to detect that the tape T cut by the cutter 31 is discharged from the tape discharge port 24 and to detect the tape end.

The control unit 44 includes a central processing unit (CPU) 44a, a read only memory (ROM) 44b, and a random access memory (RAM) 44c.

The CPU 44a performs various kinds of control by loading a control program such as firmware stored in the ROM 44b into the RAM 44c and executing the control program. The control unit 44 may use a hardware circuit such as an ASIC as a processor instead of the CPU 44a. Further, the processor may have a configuration in which one or more CPUs and a hardware circuit such as an ASIC operate in cooperation with each other.

The print head 26 includes a heating element group (not shown), and performs printing by thermally transferring ink from the ink ribbon R to the tape T. The heating element group is a plurality of heating elements arranged in the Z-axis direction.

The printing unit 45 includes the platen drive shaft 25, the discharge driving roller 33a, the feed motor 45a, and a discharge motor 45b. The platen drive shaft 25 engages with the platen roller 17 to rotate the platen roller 17. The discharge driving roller 33a pinches the tape T between the discharge driving roller 33a and the discharge driven roller 33b, and feeds the tape T toward the tape discharge port 24.

The feed motor 45a is a drive source of the platen drive shaft 25 and the discharge driving roller 33a. In addition, the discharge motor 45b is a drive source of the discharge driving roller 33a. The feed motor 45a rotates from the start of print processing to the end of printing, and the discharge motor 45b rotates after the printing is finished and the tape T is cut.

Here, the print processing is processing started by acquisition of a print start command and indicates a series of processing based on print data to be a target of the print start command. For example, the print processing includes driving of the print head 26, feeding of the tape T, and cutting of the tape T. In addition, the start of printing means the start of driving of the print head 26 and feeding of the tape T in the −X direction. On the other hand, the finish of printing means the finish of driving of the print head 26 based on the print data and the finish of feeding of the tape T in the −X direction. For example, in a case where a tape piece having a margin area in the +X direction of the print target area ES of the tape T as illustrated in FIG. 5 is formed, when the feeding of the tape T in the −X direction by the margin area is finished after the driving of the print head 26 is finished, the printing is finished. In the print processing, the tape T is cut after the printing is finished.

The cutting unit 46 includes a cutter motor 46a and the cutter 31. The cutter motor 46a is a drive source that drives the cutter 31. When the cutter motor 46a is driven, the cutter 31 is operated, and the tape T is cut in the Z-axis direction.

Here, the function of the control unit 44 in the configuration of the tape printing device 1 illustrated in FIG. 6 will be described. The control unit 44 detects, based on the detection result of the upstream sensor S1, that the leading end of the tape T has passed through the first detection position. In addition, the control unit 44 detects, based on the detection result of the downstream sensor S2, that the tape T cut by the cutter 31 is discharged from the tape discharge port 24. Further, the control unit 44 detects the tape end, based on the detection results of the upstream sensor S1 and the downstream sensor S2. In this way, the control unit 44 can perform at least three types of detection using the two sensors S.

In addition, when the absence of the tape is detected by the upstream sensor S1 and the presence of the tape is detected by the downstream sensor S2 while the tape T is being fed by the platen roller 17, the control unit 44 detects the tape end.

Further, the control unit 44 detects the tape end when the presence of the tape is detected by the upstream sensor S1 and the absence of the tape is detected by the downstream sensor S2 after a feeding amount of the tape T from the start of feeding of the tape T by the platen roller 17 exceeds a predetermined amount. In the present embodiment, the “feeding amount of the tape T from the start of feeding of the tape T” means the feeding amount of the tape T from the start of printing. The predetermined amount is the second distance D2 illustrated in FIG. 4.

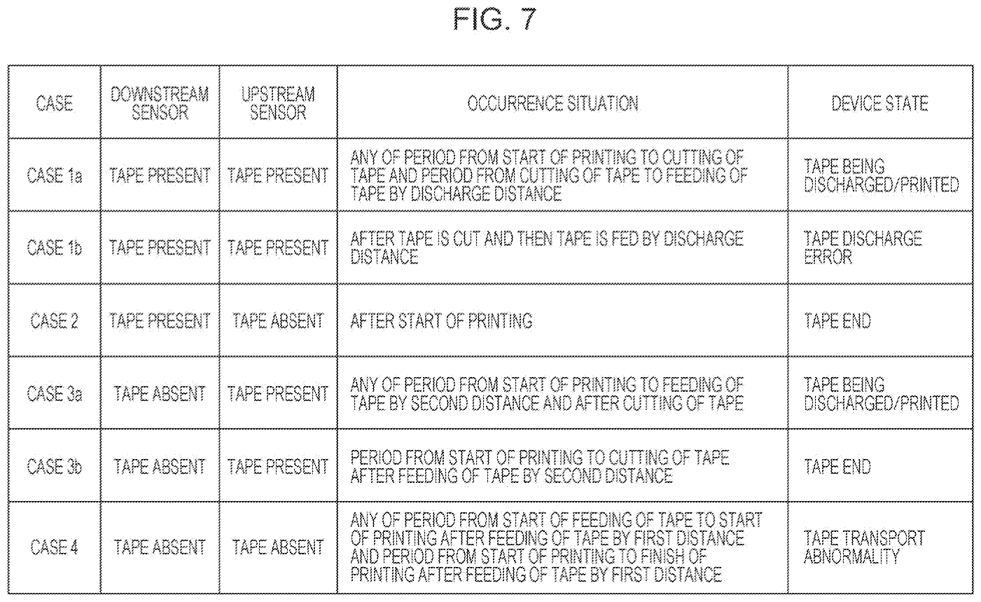

Here, the relationship between the detection results of the sensors S, the occurrence situation, and the device state will be described with reference to the table of FIG. 7. All of the occurrence situations illustrated in FIG. 7 occur in the print processing.

As shown in Case 1a, the control unit 44 determines that “the tape is being discharged or printed” when the presence of the tape is detected by the downstream sensor S2 and the presence of the tape is detected by the upstream sensor S1 in any of a period from the start of printing to the cutting of the tape T and a period from the cutting of the tape T to the feeding of the tape T by a discharge distance. The term “tape is being discharged” means a state in which the tape T is being discharged by driving of the discharge motor 45b. In addition, the term “being printed” means a state in which the tape T is being fed by driving of the feed motor 45a. Further, the discharge distance is longer than a distance between the cutter 31 and the discharge roller 33 in the X-axis direction.

In addition, as shown in Case 1b, the control unit 44 determines that a “tape discharge error” has occurred when the detection results of the sensors S are the same as those in Case 1a after the tape T is cut and then the tape T is fed by the discharge distance.

In addition, as shown in Case 2, the control unit 44 determines that the device state is “tape end” when the presence of the tape is detected by the downstream sensor S2 and the absence of the tape is detected by the upstream sensor S1 after the start of printing.

In addition, as shown in Case 3a, the control unit 44 determines that “the tape is being discharged or printed” when the absence of the tape is detected by the downstream sensor S2 and the presence of the tape is detected by the upstream sensor S1 in any of a period from the start of printing to the feeding of the tape T by the second distance D2 illustrated in FIG. 4 and at the time after the tape T is cut.

In addition, as shown in Case 3b, the control unit 44 determines that the state is “tape end” when the detection results of the sensors S are the same as those of Case 3a in a period from the start of printing to the cutting of the tape T after feeding of the tape T by the second distance D2.

In addition, as shown in Case 4, the control unit 44 determines that there is “tape transport abnormality” when the absence of the tape is detected by the downstream sensor S2 and the absence of the tape is detected by the upstream sensor S1 in the following occurrence situation. The situation is any of a period from the start of feeding of the tape T to the start of printing after feeding of the tape T by the first distance D1 and a period from the start of printing to the finish of printing after feeding of the tape T by the first distance D1. Note that the feeding of the tape T means feeding of the tape T for performing cueing of the tape T after the print processing is started.

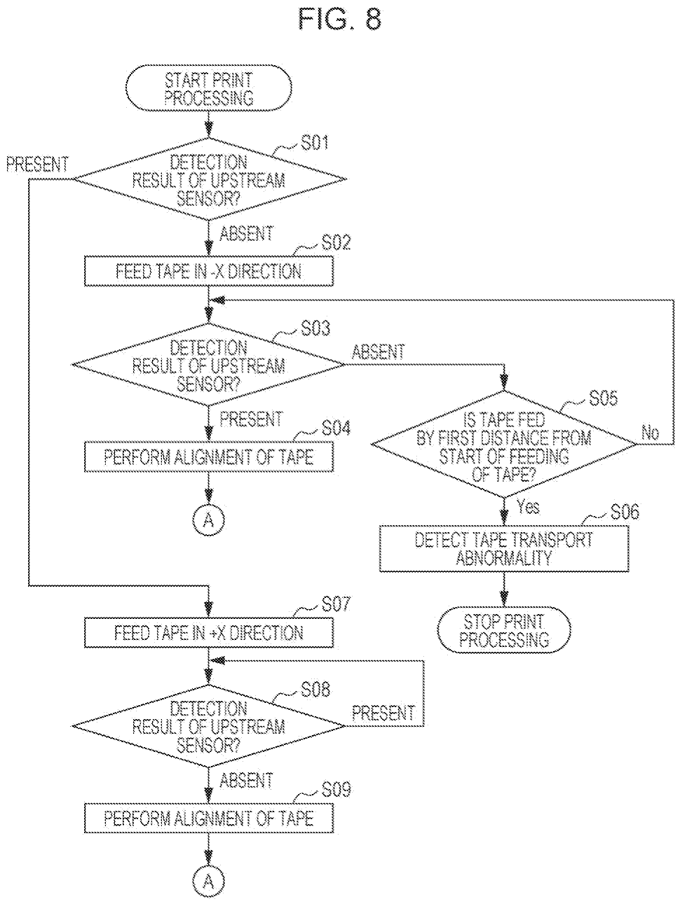

Next, a flow of print processing of the tape printing device 1 will be described with reference to flowcharts of FIG. 8 to FIG. 10. The print processing of the tape printing device 1 is an example of a “control method of a tape detection device”. The print processing is started when the control unit 44 acquires a print start command. As described above, when acquiring the print start command, the control unit 44 generates the print data based on the editing result of the print image by the user. The print processing described below is performed based on the print data.

It is assumed that the downstream sensor S2 detects the absence of the tape at the time of starting the print processing. This is because it is assumed that the tape T is cut by the cutter 31 and the cut tape T is discharged from the tape discharge port 24 at the end of the print processing. The control unit 44 may start the print processing after acquiring the print start command and subsequently performing the cut and discharge of the tape T, in order to ensure a situation in which the downstream sensor S2 detects the absence of the tape at the time of starting the print processing.

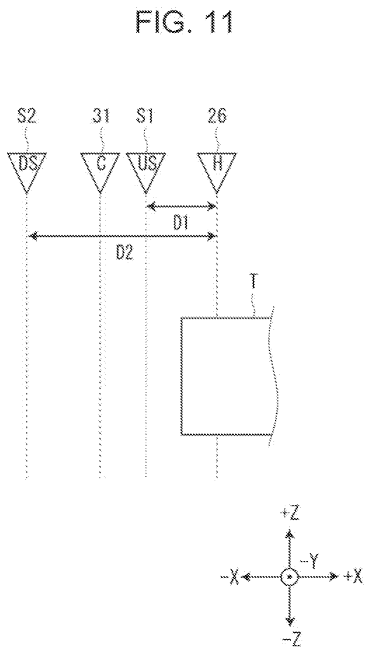

In step S01, the control unit 44 determines the detection result of the upstream sensor S1. When the control unit 44 determines that the detection result of the upstream sensor S1 is the absence of the tape, the process proceeds to step S02. FIG. 11 illustrates the position of the tape T in this case. In this case, the leading end of the tape T is located further in the +X direction than is the first detection position which is the detection position of the upstream sensor S1.

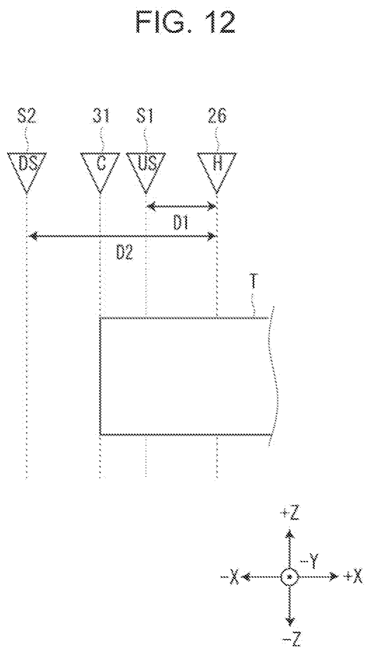

When the control unit 44 determines that the detection result of the upstream sensor S1 is the presence of the tape, the process proceeds to step S07. FIG. 12 illustrates the position of the tape T in this case. In this case, the leading end of the tape T is located further in the −X direction than is the first detection position.

In step S02, the control unit 44 feeds the tape T in the −X direction.

In step S03, the control unit 44 determines the detection result of the upstream sensor S1. When the control unit 44 determines that the detection result of the upstream sensor S1 is the absence of the tape, the process proceeds to step S05. When the control unit 44 determines that the detection result of the upstream sensor S1 is the presence of the tape, the process proceeds to step S04. The control unit 44 detects that the leading end of the tape T being fed in the −X direction has passed through the first detection position, based on the determination that the tape is present.

In step S04, the control unit 44 performs cueing of the tape T. The term “performing cueing of the tape T” means that the print start position of the tape T is set at the printing position by the print head 26.

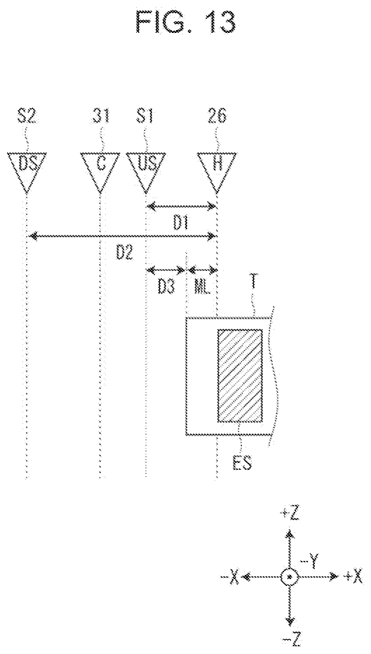

The control unit 44 performs the cueing by classifying cases as below. When the margin length ML of the tape T is smaller than the first distance D1, as illustrated in FIG. 13, the control unit 44 performs cueing of the tape T by detecting that the leading end of the tape T has passed through the first detection position and then feeding the tape T in the +X direction by a third distance D3. The third distance D3 is obtained by subtracting the margin length ML from the first distance D1.

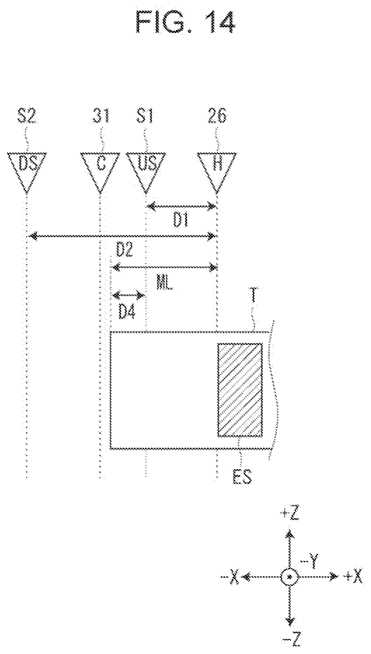

On the contrary, when the margin length ML of the tape T is larger than the first distance D1, as illustrated in FIG. 14, the control unit 44 performs cueing of the tape T by detecting that the leading end of the tape T has passed through the first detection position and then feeding the tape T in the −X direction by a fourth distance D4. The fourth distance D4 is obtained by subtracting the first distance D1 from the margin length ML.

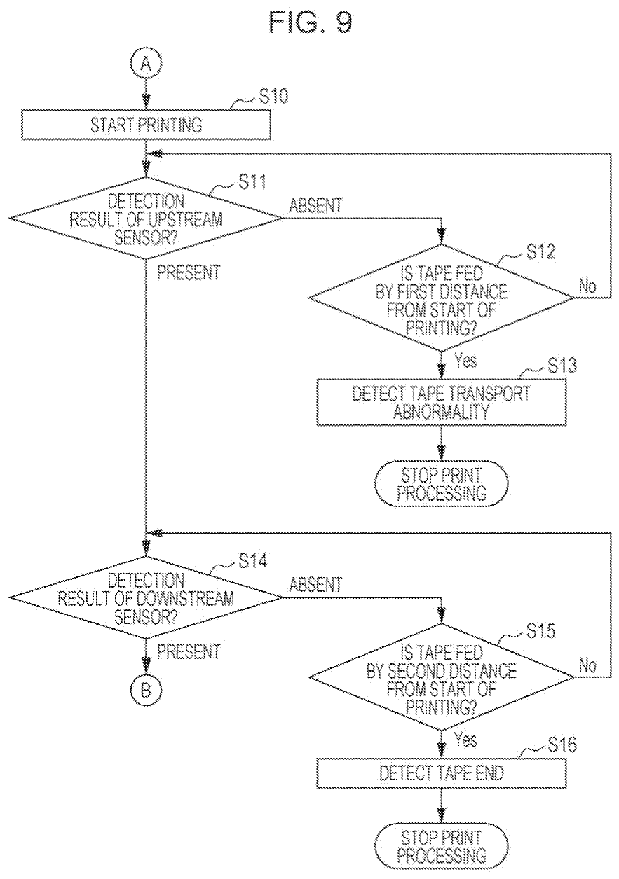

After step S04, the control unit 44 proceeds to step S10 in FIG. 9.

In step S05, the control unit 44 determines whether or not the tape T is fed by the first distance D1 from the start of feeding of the tape T. Here, the control unit 44 determines whether or not the feed motor 45a is rotated by an amount by which the tape T is fed by the first distance D1 in the −X direction from the start of the feeding of the tape T, that is, the start of print processing. When the control unit 44 determines that the tape T is fed by the first distance D1 from the start of feeding of the tape T, the process proceeds to step S06. When the control unit 44 determines that the tape T is not fed by the first distance D1 from the start of feeding of the tape T, the process returns to step S03.

In step S06, the control unit 44 detects a tape transport abnormality. The state in which the tape transport abnormality is detected corresponds to “Case 4” in the table illustrated in FIG. 7. That is, this state corresponds to a case in which the absence of the tape is detected by the downstream sensor S2 and the absence of the tape is detected by the upstream sensor S1 in a period from the start of feeding of the tape T to the start of printing after the tape T is fed by the first distance D1.

The tape T at this time is in a state as illustrated in FIG. 11, for example. That is, the tape T at this time is in a state in which the leading end of the tape T does not pass through the first detection position even though the feed motor 45a is rotated so as to feed the tape T in the −X direction by the first distance D1 from the start of feeding of the tape T. Such a situation occurs, for example, when the tape T fed from the tape cartridge C is not fed to the tape discharge path 27 and a tape jam occurs. When detecting the tape transport abnormality, the control unit 44 stops the print processing. At this time, the control unit 44 may perform notification control for notifying the user of the tape transport abnormality. For example, the control unit 44 may display, as the notification control, a message indicating the tape transport abnormality on the display 22. In other notification control below, a message indicating the detection result may also be displayed on the display 22.

In step S07, the control unit 44 feeds the tape T in the +X direction.

In step S08, the control unit 44 determines the detection result of the upstream sensor S1. When the control unit 44 determines that the detection result of the upstream sensor S1 is the presence of the tape, step S08 is repeated. When the control unit 44 determines that the detection result of the upstream sensor S1 is the absence of the tape, the process proceeds to step S09. The control unit 44 detects, based on the determination of the absence of the tape, that the leading end of the tape T being fed in the +X direction has passed through the first detection position.

In step S09, the control unit 44 performs cueing of the tape T. The cueing of the tape T is performed in the same manner as in step S04. After step S09, the control unit 44 proceeds to step S10 of FIG. 9.

In step S10 of FIG. 9, the control unit 44 starts printing. The start of printing means that the feeding of the tape T in the −X direction and the driving of the print head 26 are started.

In step S11, the control unit 44 determines the detection result of the upstream sensor S1. When the control unit 44 determines that the detection result of the upstream sensor S1 is the absence of the tape, the process proceeds to step S12. When the control unit 44 determines that the detection result of the upstream sensor S1 is the presence of the tape, the process proceeds to step S14.

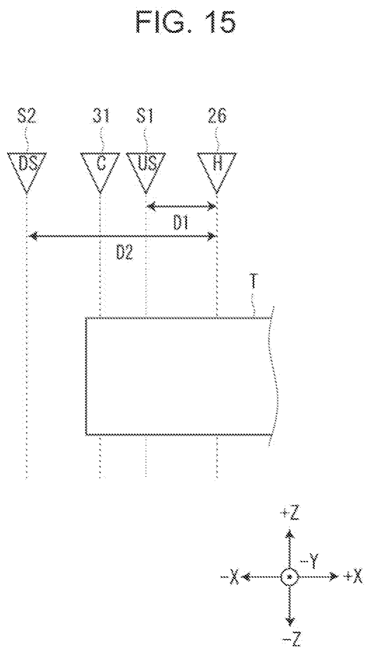

When the detection result of the upstream sensor S1 is the presence of the tape, the tape T is in a state as illustrated in FIG. 15, for example. For example, that is, when the margin length ML of the tape T is smaller than the first distance D1, printing is started, and the leading end of the tape T has passed through the first detection position due to the tape T being fed in the −X direction. When the margin length ML of the tape T is larger than the first distance D1, the leading end of the tape T has moved in the −X direction.

The situation determined that the detection result of the upstream sensor S1 is the presence of the tape corresponds to “Case 3a” in the table illustrated in FIG. 7. That is, this corresponds to a case in which the absence of the tape is detected by the downstream sensor S2 and the presence of the tape is detected by the upstream sensor S1 in a period from the start of printing to the feeding of the tape T by the second distance D2. In this case, the control unit 44 determines that “printing is being performed”.

In step S12, the control unit 44 determines whether or not the tape T is fed by the first distance D1 from the start of printing. Here, the control unit 44 determines whether or not the feed motor 45a is rotated by an amount by which the tape T is fed by the first distance D1 in the −X direction from the start of printing. When the control unit 44 determines that the tape T is fed by the first distance D1 from the start of printing, the process proceeds to step S13. When the control unit 44 determines that the tape T is not fed by the first distance D1 from the start of printing, the process returns to step S11.

In step S13, the control unit 44 detects a tape transport abnormality. The state in which the tape transport abnormality is detected corresponds to “Case 4” in the table illustrated in FIG. 7. That is, this corresponds to a case in which the absence of the tape is detected by the downstream sensor S2 and the absence of the tape is detected by the upstream sensor S1 in a period from the start of printing to the end of printing after the tape T is fed by the first distance D1.

The tape T at this time is in a state as illustrated in FIG. 13, for example. That is, when the margin length ML of the tape T is smaller than the first distance D1, the leading end of the tape T does not pass through the first detection position even though the feed motor 45a is rotated so as to feed the tape T in the −X direction by the first distance D1 from the start of printing. When detecting the tape transport abnormality, the control unit 44 stops the print processing. At this time, the control unit 44 may perform notification control for notifying the user of the tape transport abnormality.

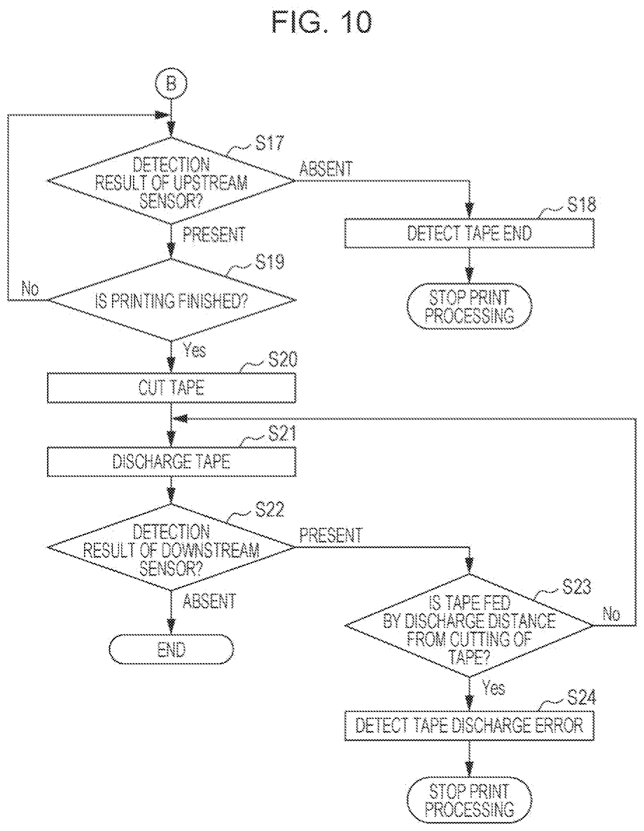

In step S14, the control unit 44 determines the detection result of the downstream sensor S2. When the control unit 44 determines that the detection result of the downstream sensor S2 is the absence of the tape, the process proceeds to step S15. When the control unit 44 determines that the detection result of the downstream sensor S2 is the presence of the tape, the process proceeds to step S17 of FIG. 10.

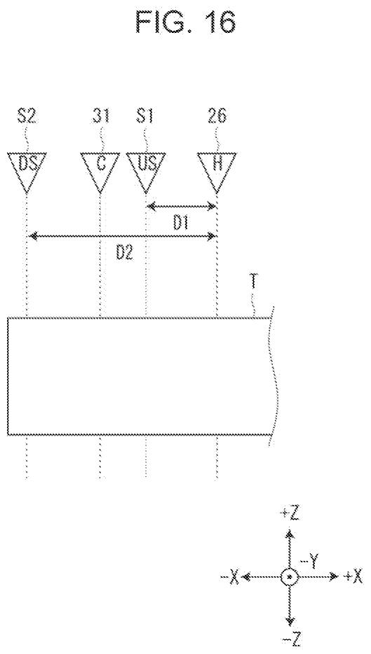

The tape T is in a state as illustrated in FIG. 16, for example, when the detection result of the downstream sensor S2 determined is presence of the tape. That is, the printing further progresses from the state of FIG. 15, and the leading end of the tape T has passed through the second detection position due to the tape T being fed in the −X direction. This state corresponds to “Case 1a” in the table illustrated in FIG. 7. That is, this corresponds to a case in which the presence of the tape is detected by the downstream sensor S2 and the presence of the tape is detected by the upstream sensor S1 in a period from the start of printing to the cutting of the tape T. In this case, the control unit 44 determines that “printing is being performed”.

In step S15, the control unit 44 determines whether or not the tape T is fed by the second distance D2 from the start of printing. Here, the control unit 44 determines whether or not the feed motor 45a is rotated by an amount that feeds the tape T in the −X direction by the second distance D2 from the start of printing. When the control unit 44 determines that the tape T is fed by the second distance D2 from the start of printing, the process proceeds to step S16. When the control unit 44 determines that the tape T is not fed by the second distance D2 from the start of printing, the process returns to step S14.

In step S16, the control unit 44 detects the tape end. This state in which the tape end is detected corresponds to “Case 3b” in the table illustrated in FIG. 7. That is, this corresponds to a case in which the absence of the tape is detected by the downstream sensor S2 and the presence of the tape is detected by the upstream sensor S1 in a period from the start of printing to the cutting of the tape T after the tape T is fed by the second distance D2.

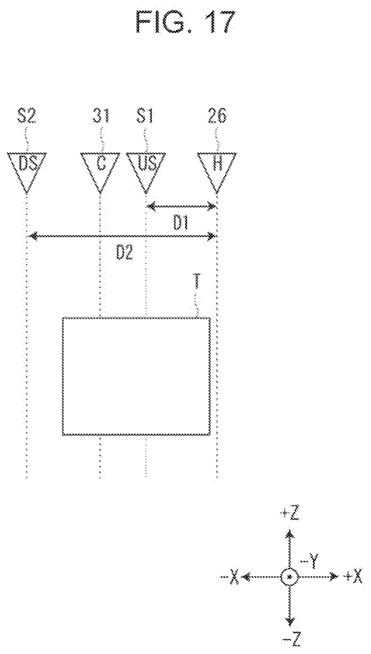

The tape T at this time is in a state as illustrated in FIG. 17, for example. That is, the leading end of the tape T does not pass through the second detection position even though the feed motor 45a is rotated so as to feed the tape T in the −X direction by the second distance D2 from the start of printing. Such a situation occurs, for example, when the terminal end of the tape T has passed through the platen roller 17 before the leading end of the tape T reaches the discharge roller 33. When the tape end is detected, the control unit 44 stops the print processing. At this time, the control unit 44 may perform notification control for notifying the user of the tape end.

In step S17 in FIG. 10, the control unit 44 determines the detection result of the upstream sensor S1. When the control unit 44 determines that the detection result of the upstream sensor S1 is the absence of the tape, the process proceeds to step S18. When the control unit 44 determines that the detection result of the upstream sensor S1 is the presence of the tape, the process proceeds to step S19.

When the detection result of the upstream sensor S1 determined is the presence of the tape, the tape T is in a state as illustrated in FIG. 16, for example. This state corresponds to “Case 1a” in the table illustrated in FIG. 7. That is, this state corresponds to a case in which the presence of the tape is detected by the downstream sensor S2 and the presence of the tape is detected by the upstream sensor S1 in a period from the start of printing to the cutting of the tape T. In this case, the control unit 44 determines that “printing is being performed”.

In step S18, the control unit 44 detects the tape end. This state in which the tape end is detected corresponds to “Case 2” in the table illustrated in FIG. 7. That is, this situation corresponds to a case in which, after the start of printing, the presence of the tape is detected by the downstream sensor S2 and the absence of the tape is detected by the upstream sensor S1.

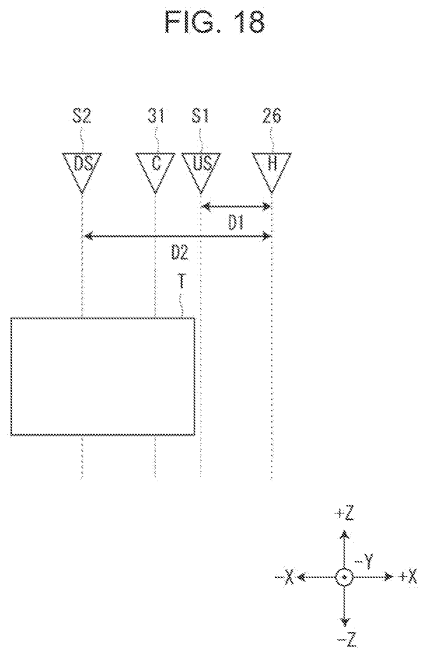

The tape T at this time is in a state as illustrated in FIG. 18, for example. That is, the leading end of the tape T has passed through the second detection position and the terminal end of the tape T has passed through the first detection position. When the tape end is detected, the control unit 44 stops the print processing. At this time, the control unit 44 may perform notification control for notifying the user of the tape end. In this case, the control unit 44 may rotate the discharge motor 45b by the discharge distance to discharge the tape T from the tape discharge port 24 before stopping the print processing.

In step S19, the control unit 44 determines whether or not printing is finished. That is, the control unit 44 determines whether or not the driving of the print head 26 based on the print data and the feeding of the tape T in the −X direction are finished. When the control unit 44 determines that the printing is finished, the process proceeds to step S20. When the control unit 44 determines that the printing is not finished, the process returns to step S17.

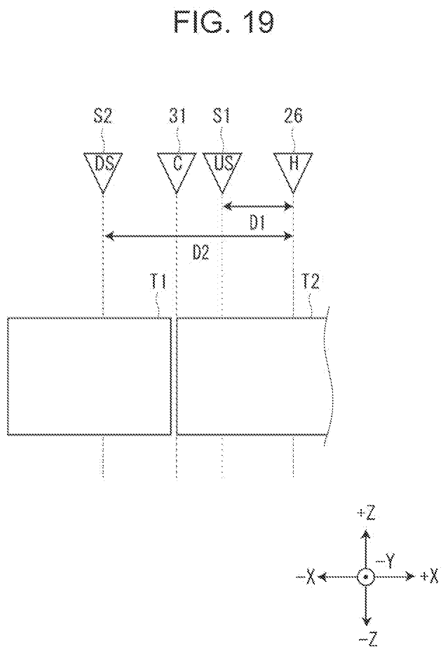

In step S20, the control unit 44 controls the cutter 31 to cut the tape T. That is, the control unit 44 drives the cutter motor 46a. FIG. 19 is a view illustrating a state in which the tape T is cut. In FIG. 19, a first tape T1 is the tape T in which the printing is finished and the tape terminal end is cut. A second tape T2 is a tape T on which printing is to be performed next.

In step S21, the control unit 44 controls the discharge roller 33 to discharge the tape T from the tape discharge port 24. That is, the control unit 44 causes the discharge motor 45b to rotate. Accordingly, in FIG. 19, the first tape T1 is fed toward the tape discharge port 24.

In step S22, the control unit 44 determines the detection result of the downstream sensor S2. When determining that the detection result of the downstream sensor S2 is the absence of the tape, the control unit 44 finishes the print processing. That is, the control unit 44 stops the rotation of the discharge motor 45b.

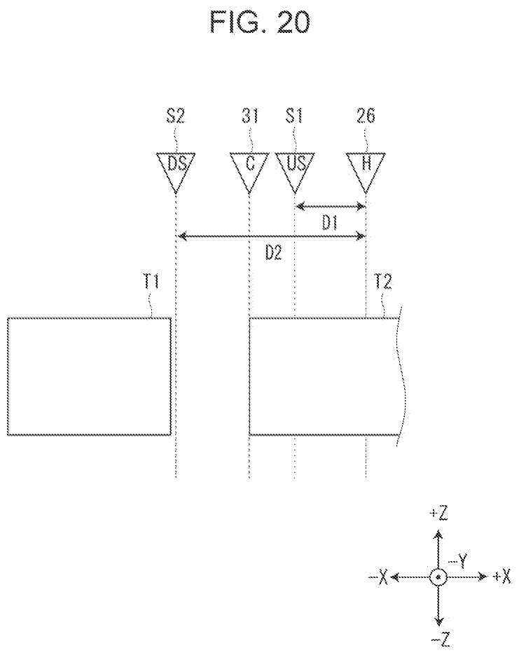

When the detection result of the downstream sensor S2 determined is the absence of the tape, the tape T is in a state as illustrated in FIG. 20, for example. That is, the first tape T1 of which the tape terminal end is cut is discharged from the tape discharge port 24 by the discharge roller 33. This state corresponds to “Case 3a” in the table illustrated in FIG. 7. That is, this state corresponds to a case in which, after the tape T is cut, the absence of the tape is detected by the downstream sensor S2 and the presence of the tape is detected by the upstream sensor S1. In this case, the control unit 44 determines that “the tape is being discharged”.

In step S23, the control unit 44 determines whether or not the tape T is fed by the discharge distance after the cutting of the tape T. Here, the control unit 44 determines whether or not the discharge motor 45b is rotated by an amount that feeds the tape T by the discharge distance in the −X direction from the cutting of the tape T. When the control unit 44 determines that the tape T is fed by the discharge distance from the cutting of the tape T, the process proceeds to step S24. When the control unit 44 determines that the tape T is not fed by the discharge distance from the cutting of the tape T, the process returns to step S21.

When being determined that the tape T is not fed by the discharge distance from the cutting of the tape T, the tape T is in a state as illustrated in FIG. 19, for example. That is, the terminal end of the first tape T1 of which the tape terminal end is cut does not pass through the second detection position. This state corresponds to “Case 1a” in the table illustrated in FIG. 7. That is, this state corresponds to a case in which the presence of the tape is detected by the downstream sensor S2 and the presence of the tape is detected by the upstream sensor S1 in a period from the cutting of the tape T to the feeding of the tape T by the discharge distance. In this case, the control unit 44 determines that “the tape is being discharged”.

In step S24, the control unit 44 detects a tape discharge error. The state in which the tape discharge error is detected corresponds to “Case 1b” in the table illustrated in FIG. 7. That is, this state corresponds to a case in which the presence of the tape is detected by the downstream sensor S2 and the presence of the tape is detected by the upstream sensor S1 after the tape T is cut and then the tape T is fed by the discharge distance.

The tape T at this time is in a state as illustrated in FIG. 19, for example. That is, although the discharge motor 45b is rotated so as to feed the tape T by the discharge distance from the cutting of the tape T, the tape T is not discharged from the tape discharge port 24 and the tape T remains at the second detection position. When detecting the tape discharge error, the control unit 44 stops the print processing. At this time, the control unit 44 may perform notification control for notifying the user of the tape discharge error.

As described above, the tape printing device 1 according to the present embodiment can perform three or more types of detection including the detection of the passage of the leading end of the tape T through the first detection position, the detection of the discharge of the tape T from the tape discharge port 24, and the detection of the tape end, using the two sensors S of the upstream sensor S1 and the downstream sensor S2. In other words, the tape printing device 1 can use each of the upstream sensor S1 and the downstream sensor S2 for a plurality of types of detection.

In addition, the tape printing device 1 detects the tape end when the absence of the tape is detected by the upstream sensor S1 and the presence of the tape is detected by the downstream sensor S2 while the tape T is being fed by the platen roller 17. As a result, the tape printing device 1 can detect the tape end earlier than when only the downstream sensor S2 is used.

In addition, the tape printing device 1 detects the tape end when the presence of the tape is detected by the upstream sensor S1 and the absence of the tape is detected by the downstream sensor S2 after the tape T is fed by the second distance D2 from the start of printing. Thus, the tape printing device 1 can detect that the tape end has been reached before the leading end of the tape T is fed to the second detection position.

In addition, the tape printing device 1 detects the presence/absence of the tape T by using the pinched position of the discharge roller 33 as the second detection position. Accordingly, since the tape printing device 1 does not needs to arrange the discharge roller 33 and the downstream sensor S2 side by side in the X-axis direction, it is possible to achieve space saving.

The present disclosure is not limited to the above embodiment, and the following modifications can be adopted.

### Modification 1

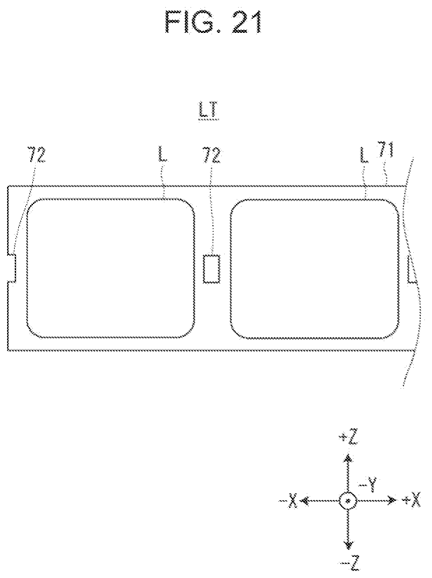

The tape printing device 1 may use, as the tape T, a label tape LT as illustrated in FIG. 21. The label tape LT is formed by arranging a plurality of labels L on a mount tape 71 at equal intervals in the X-axis direction. In the label tape LT, a detection hole 72 serving as a detection target portion is provided between the labels L in the X-axis direction. The detection hole 72 is formed by cutting out the mount tape 71 in a rectangular shape and is provided at substantially the center of the mount tape 71 in the Z-axis direction. In this case, the detection position of the upstream sensor S1 is substantially the center of the mount tape 71 in the Z-axis direction. The tape printing device 1 can perform printing at a desired position on the label L by detecting the detection hole 72 by the upstream sensor S1 and performing cueing of each of the labels L. The tape printing device 1 detects, for example, an end portion of the detection hole 72 in the +X direction. In this case, the end portion of the detection hole 72 in the +X direction is an example of the “specific position other than the terminal end of the tape”.

The detection target portion for performing the cueing may be provided at an end portion in the +Z direction or an end portion in a −Z direction instead of being provided at substantially the center of the mount tape 71 in the Z-axis direction. For example, the detection hole 72 may be formed at the end portion in the +Z direction or the end portion in the −Z direction of the mount tape 71. In this case, the upstream sensor S1 sets the end portion in the +Z direction or the end portion in the −Z direction of the mount tape 71 as the detection position. In this manner, the upstream sensor S1 is provided at a position corresponding to the detection target portion in the Z-axis direction. That is, the upstream sensor S1 is not limited to being provided at substantially the center of the mount tape 71 in the Z-axis direction.

Alternatively, a mark printed on the mount tape 71 of the label tape LT may be used as the detection target portion.

In addition, the label L itself may be used as the detection target portion. In this case, the upstream sensor S1 may detect an end portion position of the label L in the −X direction. In this case, the mount tape 71 may be a transparent tape.

In Modification 1, the tape printing device 1 performs the control of cueing of the label tape LT based on the detection of the detection target portion instead of detection of the leading end of the label tape LT.

### Modification 2

The downstream sensor S2 may be provided between the cutter 31 and the discharge roller 33 or between the discharge roller 33 and the tape discharge port 24.

In addition, the downstream sensor S2 may be, similarly to the upstream sensor S1, a transmission-type sensor including a light-emitting element and a light-receiving element that are arranged to face each other with the tape T interposed therebetween.

In addition, the upstream sensor S1 and the downstream sensor S2 may be reflective sensors instead of the transmission-type sensors.

### Modification 3

The tape printing device 1 may or may not have a configuration in which the tape cartridge C can be mounted. For example, the tape printing device 1 may include a platen roller and perform printing on the tape T supplied from the outside of the tape printing device 1.

### Modification 4

The tape printing device 1 may detect a setting failure of the tape cartridge C in addition to the detection described in the above embodiment. For example, the tape printing device 1 may detect the setting failure in a case in which the upstream sensor S1 detects the absence of the tape when the mounting portion cover 5 is closed. Such a setting failure occurs, for example, when the tape cartridge C is mounted on the cartridge mounting portion 23 in a state in which the leading end of the tape T protruding from the tape outlet port 13 is folded. When detecting the setting failure, the tape printing device 1 may perform notification control for notifying the user of the setting failure.

### Modification 5

The tape printing device 1 may notify the user that the tape is being discharged or printed, in addition to the notification of the tape end, the tape discharge error, and the tape transport abnormality. In addition, the tape printing device 1 may notify the user that the tape is being discharged and the tape is being printed in a distinguishable manner.

In addition, the tape printing device 1 may notify the user of the tape end, the tape discharge error, and the tape transport abnormality in a distinguishable manner.

### Modification 6

The second distance D2 is not limited to the distance between the printing position and the second detection position in the X-axis direction, and may be longer than the distance between the printing position and the second detection position in the X-axis direction.

### Modification 7

The “tape end detection device” can also be applied to devices other than the tape printing device 1. For example, the “tape end detection device” can also be applied to a device that does not have a printing function on the tape T and cuts the tape T.

### Modification 8

The firmware of the tape printing device 1 may be provided to a customer as a program. Alternatively, a storage medium in which the firmware of the tape printing device 1 is recorded may be provided to the customer. Further, the tape printing device 1 may employ another printing method such as an ink jet method in addition to the thermal transfer method. In addition, appropriate changes can be made without departing from the gist of the present disclosure.

### Supplementary Note

Hereinafter, a tape end detection device, a tape printing device, and a control method of a tape end detection device will be additionally described.

The tape printing device 1 includes: the cutter 31 that is provided further in the −X direction than is the platen roller 17 feeding the tape T fed out of the tape roll 16 in the first direction and cuts the tape T in the tape width direction; the discharge roller 33 that is provided further in the −X direction than is the cutter 31 and feeds the tape T in the −X direction toward the tape discharge port 24; the upstream sensor S1 that detects presence/absence of the tape T at the first detection position located between the platen roller 17 and the cutter 31; the downstream sensor S2 that detects presence/absence of the tape T at the second detection position located between the cutter 31 and the tape discharge port 24; and the control unit 44. The control unit 44 detects, based on the detection result of the upstream sensor S1, that a specific position other than the terminal end of the tape T has passed through the first detection position, detects, based on the detection result of the downstream sensor S2, that the tape T cut by the cutter 31 has been discharged from the tape discharge port 24, and detects, based on the detection results of the upstream sensor S1 and the downstream sensor S2, the tape end indicating that the terminal end of the tape T has passed through the platen roller 17.

The control method of the tape printing device 1 is a method for controlling the tape printing device 1. The tape printing device 1 includes: the cutter 31 that is provided further in the −X direction than is the platen roller 17 feeding the tape T fed out of the tape roll 16 in the −X direction and cuts the tape T in the tape width direction; the discharge roller 33 that is provided further in the −X direction than is the cutter 31 and feeds the tape T in the −X direction toward the tape discharge port 24; the upstream sensor S1 that detects presence/absence of the tape T at the first detection position located between the platen roller 17 and the cutter 31; and the downstream sensor S2 that detects presence/absence of the tape T at the second detection position located between the cutter 31 and the tape discharge port 24. The control method of the tape printing device 1 includes: detecting, based on the detection result of the upstream sensor S1, that a specific position other than the terminal end of the tape T has passed through the first detection position, detecting, based on the detection result of the downstream sensor S2, that the tape T cut by the cutter 31 has been discharged from the tape discharge port 24, and detecting, based on the detection results of the upstream sensor S1 and the downstream sensor S2, the tape end indicating that the terminal end of the tape T has passed through the platen roller 17.

According to this configuration, the tape printing device 1 can perform, using the two sensors S, three types of detection: detection of the passage of the specific position of the tape T through the first detection position, detection of the discharge of the tape T from the tape discharge port 24, and detection of the tape end. In other words, the tape printing device 1 can use one sensor S for a plurality of types of detection.

In the above-described tape printing device 1, the control unit 44 may detect the tape end when absence of the tape is detected by the upstream sensor S1 and presence of the tape is detected by the downstream sensor S2 while the tape T is being fed by the platen roller 17.

According to this configuration, the tape printing device 1 can detect the tape end earlier than when only the downstream sensor S2 is used.

In the above tape printing device 1, the control unit 44 may detect the tape end when presence of the tape is detected by the upstream sensor S1 and absence of the tape is detected by the downstream sensor S2 after the feeding amount of the tape T from the start of feeding of the tape T by the platen roller 17 exceeds a predetermined amount.

According to this configuration, the tape printing device 1 can detect the tape end before the leading end of the tape T is fed to the detection position of the downstream sensor S2.

In the above-described tape printing device 1, the discharge roller 33 may include a pair of rollers that pinch the tape T to rotationally feed the tape T, and the downstream sensor S2 may detect presence/absence of the tape T by setting a position between the pair of rollers as the second detection position.

According to this configuration, the tape printing device 1 sets the position between the pair of rollers of the discharge roller 33 as the second detection position to eliminate the need to arrange the discharge roller 33 and the downstream sensor S2 side by side in the X-axis direction, and thus it is possible to achieve space saving.

The tape printing device 1 includes the constituent elements of the tape printing device 1 described above, and a print head 26 that performs printing on the tape T fed by the platen roller 17.

According to this configuration, the tape printing device 1 can perform, using the two sensors S, three types of detection: detection of the passage of the specific position of the tape T through the first detection position, detection of the discharge of the tape T from the tape discharge port 24, and detection of the tape end.

What is claimed is:

1. A tape end detection device comprising:
a cutter that is provided further in a first direction than is a feed roller feeding a tape fed out of a tape roll in the first direction, and cuts the tape in a tape width direction;
a discharge roller that is provided further in the first direction than is the cutter and feeds the tape in the first direction toward a tape discharge port;
a first sensor that detects presence/absence of the tape at a first detection position located between the feed roller and the cutter;
a second sensor that detects presence/absence of the tape at a second detection position located between the cutter and the tape discharge port; and
a control unit, wherein
the control unit
detects, based on a detection result of the first sensor, that a specific position other than a terminal end of the tape passed through the first detection position,
detects, based on a detection result of the second sensor, that the tape cut by the cutter was discharged from the tape discharge port, and
detects, based on the detection results of the first sensor and the second sensor, a tape end indicating that the terminal end of the tape passed through the feed roller.

2. The tape end detection device according to claim 1, wherein
the control unit detects the tape end when absence of the tape is detected by the first sensor and presence of the tape is detected by the second sensor while the tape is being fed by the feed roller.

3. The tape end detection device according to claim 1, wherein
the control unit detects the tape end when presence of the tape is detected by the first sensor and absence of the tape is detected by the second sensor after a feeding amount of the tape from start of feeding of the tape by the feed roller exceeds a predetermined amount.

4. The tape end detection device according to claim 1, wherein
the discharge roller includes a pair of rollers that pinch the tape to rotationally feed the tape, and
the second sensor detects presence/absence of the tape by setting a position between the pair of rollers as the second detection position.

5. A tape printing device comprising:
the tape end detection device according to claim 1, and
a print head that performs printing on the tape fed by the feed roller.

6. A control method of a tape end detection device including a cutter that is provided further in a first direction than is a feed roller feeding a tape fed out of a tape roll in the first direction, and cuts the tape in a tape width direction,
a discharge roller that is provided further in the first direction than is the cutter and feeds the tape in the first direction toward a tape discharge port,
a first sensor that detects presence/absence of the tape at a first detection position located between the feed roller and the cutter, and
a second sensor that detects presence/absence of the tape at a second detection position located between the cutter and the tape discharge port,
the control method of the tape end detection device, comprising:
detecting, based on a detection result of the first sensor, that a specific position other than a terminal end of the tape passed through the first detection position,
detecting, based on a detection result of the second sensor, that the tape cut by the cutter was discharged from the tape discharge port, and
detecting, based on the detection results of the first sensor and the second sensor, a tape end indicating that the terminal end of the tape passed through the feed roller.
